(19) United States
(12) Patent Application Publication
(10) Pub. No.: US 2010/0250684 A1
(43) Pub. Date: Sep. 30, 2010

(54) HIGH AVAILABILITY METHOD AND APPARATUS FOR SHARED RESOURCES

(75) Inventor: Martin R. Naish, Berkshire (GB)

Correspondence Address: Scully, Scott, Murphy & Presser, P.C., 400 Garden City Plaza, Suite 300, Garden City, NY, 11530, US

(73) Assignee: International Business Machines Corporation, Armonk, NY (US)

(21) Appl. No.: 12/414,243

(22) Filed: Mar. 30, 2009

(51) Int. Cl. G06F 15/16; G06F 13/00

(52) U.S. Cl. 709/206; 719/314; 709/201

(57) ABSTRACT

A method, system and article of manufacture that provides a control queue that regulates access to a shared resource, a software component that manages a clients interest in the shared resource and a registration mechanism in various messaging topologies; for example, within a message-oriented middleware framework where the messaging topology is configured as a point-to-point message topology within the MOM framework or a publication-subscription messaging topology within the MOM framework.

### FIELD OF THE INVENTION

The present disclosure relates generally to a field of enterprise messaging, and more specifically, to a system and method of implementing a distributed and reliable communication system for clients connected to a messaging provider that receives messages from a shared resource or a queue.

### BACKGROUND OF THE INVENTION

Production software environments typically have a low-failure tolerance. Consequently, production software environments often require very short down times to ensure consistent service. Environments which provide very short down times are commonly also known as “high availability” processing systems and often use a “hot standby” configuration where one processing node of the system is in an idle state and only becomes active when, for any reason, the active processing node fails. This contingency approach means that the standby node takes over control automatically.

In addition, as network functionality increases, it becomes increasingly more important for systems to allow applications and application components to be distributed across networks (e.g., on multiple application servers). For applications and application components to be effectively distributed, various distributed parts of applications and application components (i.e. nodes) need to be able to communicate with each other. Nodes may communicate with each other using messaging to exchange information. To facilitate the exchange of messages, developers will often use a message-oriented middleware (MOM) framework (or system of software components and conventions that provide a message-oriented middleware architecture and features; see generally Chappell, “Enterprise Message Bus”, O'Reilly (2004)) via MOM Providers. By using a MOM Provider, the information may be sent and received by nodes using only a predetermined message format and a destination address for the message. A node may be a software component or process that runs on a common computer or different computers connected by a network or networks. A node may be a message producer and/or a consumer. The predetermined message format may include a message header for message identification, a properties section for application-specific, provider-specific, and optional header fields, and a body section that contains the content of the message. The content of a message may include text, data packets, objects, or other information to be communicated between nodes.

Several different types of messaging systems may be used for communicating between nodes including point-to-point and publish-and-subscribe. As seen in FIG. 1a, in a point-to-point messaging system (generally a one-to-one delivery), a message 105 may be sent by a message producer 101 to a message consumer 103 through a message queue 110 (also known as a virtual channel). For example, a message producer 101 may send a message 105 to a message queue 110 for a message consumer 103. The message consumer 103 receives and processes the message 105 from the message queue 110.

In addition, as seen in FIG. 1b, a publish-and-subscribe messaging system (generally a one-to-many broadcast), the message producer 101 may be a publisher for a topic 123 (also known as a virtual channel) that sends a message 115 to several message consumers (known as subscribers) that have subscribed to the topic 123. For example, the message producer 101 may send a message 115 to a topic 123. Several nodes, such as the message consumer 103 and the second message consumer 121 may subscribe (i.e., request that messages of a certain type be sent to the node when available) to the topic 123. The topic 123 may deliver the message 115 to the message consumer 103 and the second message consumer 121. Message consumers not subscribed to the topic do not receive the message.

To facilitate sending and receiving messages, nodes typically use MOM providers built to handle the special requirements of messaging within an enterprise (e.g., IBM's Websphere® MQ) to connect to a messaging agent for implementing message queues and/or topics. Enterprise messaging requires a reliable, flexible service for the asynchronous exchange of critical business data and events throughout an enterprise (or other message exchanging entity). One example of a messaging agent may be implemented according to the Java® Messaging Service (JMS). The JMS Application Programming Interface (API) operates in conjunction with an individual enterprise messaging providers' API (e.g., IBM's Websphere® MQ offers such an API) to enable the development of portable, message based applications in the Java® programming language. Under JMS, an Enterprise Messaging MOM Provider is also referred to as a JMS Provider. Messages may be sent and received asynchronously, and nodes sending and receiving messages do not typically need to know anything about the nodes they are communicating with. This allows more freedom between nodes and makes it easier to design interfaces between nodes and easier to distribute applications and application components across a network.

The addition of an Enterprise Messaging system allows for more robust system development. For example, the JMS API enhances the Java® 2 Enterprise Edition (or “J2EE”) platform by simplifying enterprise development, allowing loosely coupled, reliable, asynchronous interactions among J2EE components and legacy systems capable of messaging. Using JMS, in addition to J2EE, developers can easily add new features, in a robust manner, to a J2EE application with existing business events by adding new components (e.g., message-driven bean, as defined within the Java® API) to operate on specific business events.

In a high availability messaging solution where multiple JMS clients attempt to receive JMS messages from a shared queue under transactional control, if more than one client is able to receive messages from the queue simultaneously, then in the event of a processing failure any uncommitted messages will again be made available to any client connected to the JMS provider. However the sequence of message appearance may be changed.

Similarly, in a publish/subscribe messaging topology (hereinafter referred to as “pub-sub”), a slow subscriber can cause an imbalance in the messaging system. For example, in IBM's WebSphere® MQ PubSub, all messages for a particular subscriber are stored on a particular queue. If the subscriber “draining” that queue is on a slow machine or has limited resources (i.e. single thread), it may not be able to drain the queue quick enough to keep up with the publish rate from the broker, which can cause the queue depth to grow producing unwanted increased latency and poor performance. In other non-queue based pub-sub environments, a slow subscriber can result in a delay to the whole system as a message is not considered delivered until all messages are delivered to all subscribers. Therefore a single slow subscriber can clog the whole system.

In addition, in current pub-sub implementations, there is no way to distribute that workload across multiple threads or machines. Also, there is currently no generalized solution that offers serialized access to a shared JMS queue between JMS clients receiving input from that queue, able of preserving the integrity of the message sequence on that queue in the event of a processing failure.

Thus, it would be desirable to provide a method and apparatus for implementing a distributed and reliable communication system for JMS clients connected to a single JMS provider that receive input from a shared resource or a queue while preserving the integrity of the message sequence in the shared resource or within such queue in the event of a processing failure.

### BRIEF SUMMARY OF THE INVENTION

A method and system for controlling access to a messaging system that exchanges messages in a distributed data processing system that includes a plurality of computing devices are disclosed. A method in one aspect may comprise sending a control message from a first computing device to a storage medium on a second computing device. The storage medium includes a first queue and the control message includes a token that corresponds to a shared resource of the messaging system. The token identifies a registering computing device that has an interest-to-use the shared resource. The method may also include storing the control message on the first queue and browsing for oldest control message in the first queue. The registering computing device associated with the oldest control message gains access to the shared resource.

A system for controlling access to a messaging system that exchanges messages in a distributed data processing system that includes a plurality of computing devices, in one aspect, may comprise a computing device having a storage medium. A plurality of client computing devices is operable to send a control message to the storage medium on the computing device. The storage medium includes a first queue and the control message includes a token that corresponds to a shared resource of the messaging system. The token identifies a registering computing device that has an interest-to-use the shared resource. The plurality of client computing devices is further operable to browse for oldest control message in the first queue. The registering computing device associated with the oldest control message gains access to the shared resource.

A program storage device readable by a machine, tangibly embodying a program of instructions executable by the machine to perform methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1a illustrates an example of a point-to-point messaging system.

FIG. 1b illustrates an example of a publish-and-subscribe messaging system.

FIG. 2 illustrates a schematic overview of multiple JMS clients using Shared Queue Controllers to access a Shared JMS Queue, according to one embodiment of the present invention.

FIG. 3 illustrates a block diagram representing class collaboration between the SQC, its subordinates, the JMS client, Control Queue and the SR, according to one embodiment of the present invention.

FIG. 4 is a sequence diagram illustrating the sequence of operations undergone by an SQC, according to one embodiment of the present invention.

FIG. 5 illustrates multiple brokers access a shared JMS queue, according to one embodiment of the present invention.

FIG. 6 illustrates multiple brokers access a shared JMS queue, according to another embodiment of the present invention.

FIG. 7 illustrates an exemplary computing environment, according to one embodiment of the present invention.

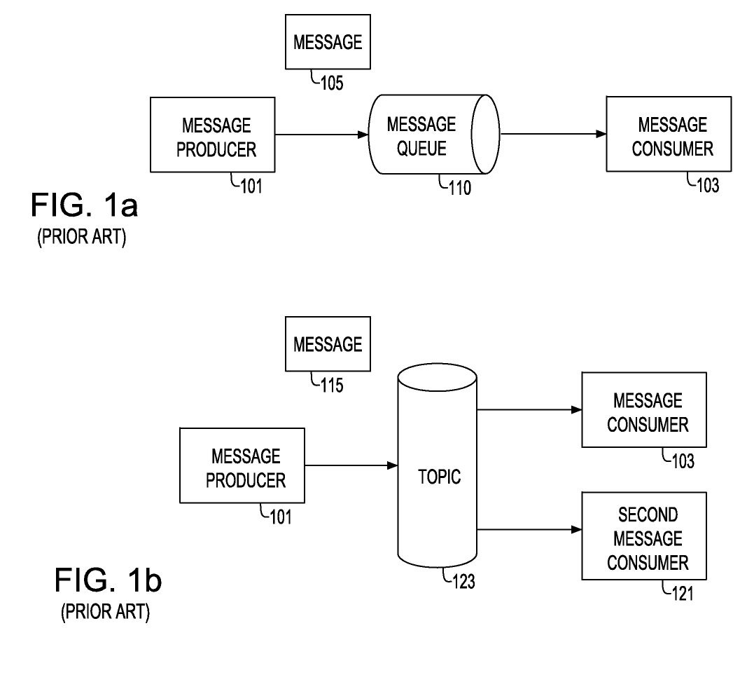

### DETAILED DESCRIPTION

According to one embodiment of the present invention, a token is defined and associated with a shared resource—e.g., a JMS queue, or a topic in a pub-sub environment. All clients that wish to have access to this shared resource register their interest, and only one of them has sole access to the shared resource at any particular time, while all the other clients wait in a “hot standby” mode. Once a client has the controlling interest, it retains ownership of the shared resource until it either explicitly relinquishes control or terminates. In the event of a processing failure, any uncommitted messages will be recovered to the shared resource, and one of the standby clients will gain ownership of the shared resource and resume message processing.

To simplify the discussion of the present invention below, one embodiment of the present invention that utilizes the Java® programming language, and particularly the JMS API extension to the J2EE, is discussed in detail. The discussion of a the JMS API, or J2EE, below, however, is not intended to be read as a limitation on the present invention and those skilled in the art would readily understand how other embodiments could be built using other data structures.

In addition, one embodiment of the present invention utilizes underlying features of a MOM implementation, as provided, for example, through a JMS Provider (such as IBM's Websphere® MQ) to preserve the messages on queue. By doing so, one embodiment of the present invention reduces the necessary overhead, thereby creating a lightweight system, by removing redundant functionality that would otherwise be provided by the MOM implementation. For example, by marking the messages on queue as “persistent” by the message originator, additional overhead associated with message maintenance is avoided because the MOM implementation already has facilities to maintain a message when the message is marked as “persistent”. In addition, messages on the queue are under the Syncpoint control (another feature of a MOM implementation, such as IBM's Websphere® MQ) of the Shared Queue Controller (hereinafter referred to as a “SQC”), which guarantees that a message will not be removed from the queue until the SQC has explicitly issued a commit call to the MOM. Thus, in the event of a failure, the “get” of the message will not be committed to any client, which will therefore assure that messages are preserved in the original sequence.

An alternative embodiment to the present invention provides a generic solution for distributed platforms using some components described in the JMS specification. This method will allow JMS messages to be consumed from a JMS queue in sequential order by multiple JMS clients connected to the same JMS provider. Thus, an alternative embodiment of the present invention ensures that the original messages' sequence is maintained at all times, including the event of a processing failure in one of the clients.

Further embodiments of the present invention provides a generic, platform independent construct that performs the functions of the SQC as described above in any MOM implementation. Such SQC manages registrations from JMS clients that have interests in a shared JMS Queue or a pub sub provider.

Thus, in accordance with one aspect of the invention, there is provided a high availability communication method for sequential processing of JMS messages from a shared resource in a distributed environment by controlling access of multiple JMS clients, each using Shared Queue Controller, connecting to the same JMS provider.

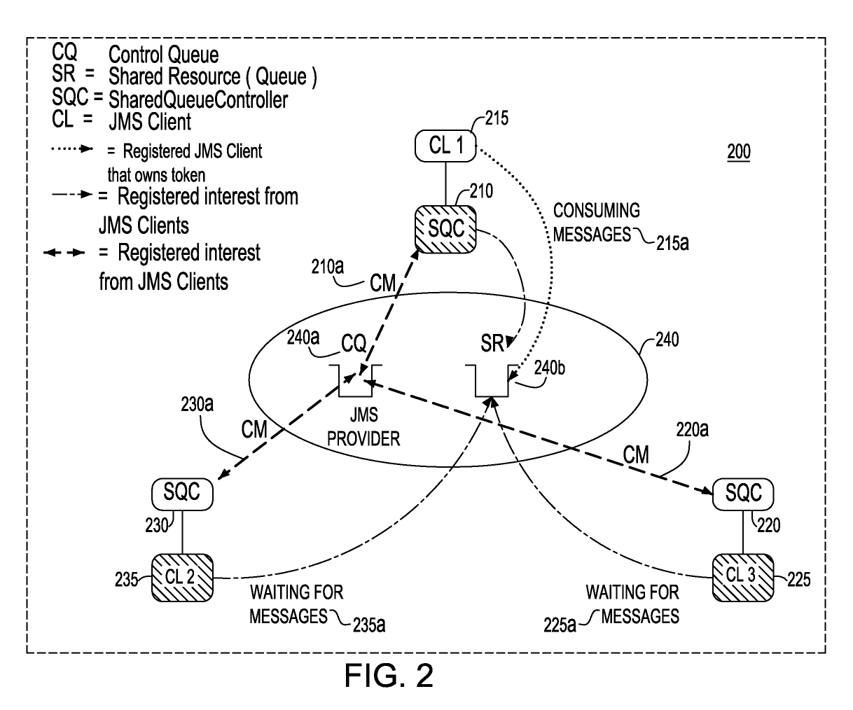

FIG. 2 is a schematic diagram illustrating the features according to one embodiment of the present invention. In FIG. 2, messaging system 200 utilizes JMS Provider 240 to facilitate communication and is a distributed system with three clients (CL1 215, CL2 225 and CL3 235) communicating with a shared resource (SR 240b). To enable assist in controlling access to SR 240b, each client communicates with a software module, the Shared Queue Controller (hereinafter referred to as a “SQC”), to determine which client has access to SR 240b, as discussed in further detail below. In general, each client communicates with one SQC, but other configurations are possible and will not be discussed further herein. Thus, as illustrated in FIG. 2, SQC 210, SQC 220 and SQC 230 are included as software modules in CL1 215, CL2 225 and CL3 235, respectively.

Each of the SQC communicates with a Control Queue (hereinafter referred to as a “CQ”), e.g., CQ 240a. The CQ controls access to a shared resource; hence, CQ 240a controls access to SR 240b illustrated in FIG. 2. Additionally, in the embodiment shown in FIG. 2, the CQ only communicates with a SQC and does not communicate with a client directly. Thus, to gain access to SR 240b, each client communicates the interest to the client's SQC (the process taken by a client of communicating an interest to an SQC is described in detail below). For example, CL1 215 would communicate its interest in SR 240b to its SQC (SQC 210), CL2 225 will communicate its interest to SQC 220 and CL3 235 will communicate its interest to SQC 230. After receiving, from a client, a communication indicating an interest in receiving data from a shared resource, each SQC registers that interest to CQ of the shared resource (the process taken by an SQC to register with a CQ is described in detail below). Thus, although not shown in FIG. 2, SQC 210, SQC 220 and SQC 230 each have registered its interest in SR 240b. To maintain the interest in the shared resource, each SQC periodically sends Control Messages (hereinafter referred to as “CM”), as described in further detail below. Each CM has a limited lifespan, and its lifespan is determined by a time-to-live period of time included in the CM instantiated by each SQC to register a client's interest in the shared resource. After the lifespan of the CM has expired, the CM is automatically removed from the CQ by the JMS Provider,

The operation of the CQ is described in detail below, but generally operates as a queue of CMs, where the CM at the end of the queue is granted access to the shared resource. Each CM, however, has a limited lifetime, and when its life expires, the CM is removed from the CQ. When a CM is removed from the CQ, the SQC (and similarly, the client) that sent the CM has lost its place in the queue, unless that SQC was the first to send a CM and the client is therefore accessing the shared resource. Otherwise, when the expired CM is not the first CM in the queue, the SQC (and its corresponding client) would no longer be given access to the shared resource if no other actions were performed by the SQC. Consequently, according to one embodiment of the present invention, each SQC re-transmits a CM to the CQ prior to the expiration of the CM to maintain the SQC's (and the client's) interest in the shared resource.

Although the contents of CQ 240a are not illustrated in FIG. 2, the practical results of those contents are illustrated. Thus, as illustrated in FIG. 2, reference character 215a indicates CL1 215 is “consuming messages” from SR 240b, Consequently, between the three clients shown in FIG. 2, CL1 215 was the first to register an interest in SR 240b, by way of CM 210a, sent via SQC 210, and stored in CQ 240a. In addition, clients CL2 225 and CL3 235 also have registered an interest in the same queue, but because CL1 215 registered its interest first, they are waiting for the opportunity to receive input (as shown by reference characters 225a and 235a). Only when the client that currently owns the queue (namely, CL1 215) either terminates or relinquishes its interest, will the next client in CQ 240a be granted access to SR 240b.

According to one embodiment of the present invention, each JMS client in a JMS Provider domain (e.g., CL1 215, CL2 225 and CL3 235) that wants to consume messages from the shared resource (e.g., SR 240b) will create a new SQC (e.g., SQC 210, SQC 220 and SQC 230) and register an interest in the shared resource using the token identifier (discussed in further detail below) associated with the shared resource (e.g., SR 240b). For example, each JMS Client may indicate an interest in a shared resource by attempting to receive a message from the shared resource through the getNextMessage( ) method call (with the shared resource name as one of the arguments) accessing via the SQC. As described in further detail below, the getNextMessage( ) method registers an interest in the shared resource when the JMS Client does not own the shared resource and requests transmission of the next JMS message (a component of the Java® JMS API) when the JMS Client is the owner of the shared resource. In response to the getNextMessage ( ) method invocation when the JMS Client is not the owner of the shared resource, the SQC creates a CM to be transmitted to the CQ corresponding to the shared resource to register the JMS Client's interest in the shared resource. According to one embodiment of the present invention, each JMS Client with an interest in the shared resource will register an interest in the shared resource via CM objects sent to the CQ. Consequently, only one JMS client at a time will be allowed to consume messages from the SR (e.g., SR 240b), and this is the client that owns oldest registered CM (e.g., CM 210a) on the CQ (e.g., CQ 240a).

Furthermore, the shared resource offers high availability to its accessing clients in the embodiment of the present invention illustrated in FIG. 2. For example, if there is an unlocked message, or a message waiting to be sent to a JMS Client, on the shared resource (e.g., SR 240b), when the owning JMS client (e.g., CL1 215) calls getNextMessage( ) then that message will be returned to the client, so that the current owner of the shared resource may finish processing the unlocked message. In a process described in additional detail below, the JMS message may be de-queued from the shared resource when the ownership of the shared resource changes, depending upon the transactional requirements specified when the client first registered with its SQC (in a process described in detail below). Consequently, since the current owner of the shared resource is able to process JMS Messages unlocked by the previous owner, the current owner of the shared resource operates as the “hot standby” the previous owner of the shared resource.

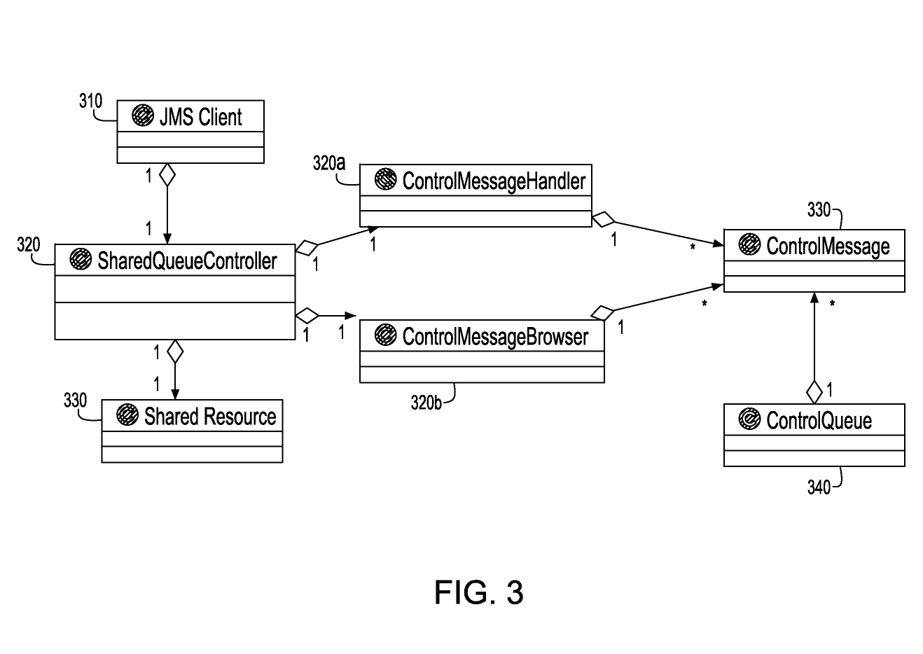

FIG. 3 illustrates additional detail of the software components described above, according to one embodiment of the present invention. As illustrated in FIG. 3, each component is described as a class in the Java® object-oriented programming language. The use of Java®, however, is for illustrative purposes only, and not to be viewed as a limitation on the present invention. Those skilled in the art could, without undue experimentation, use what is illustrated in FIG. 3 to prepare instructions that adapts a general purpose computing device to perform the specific operations illustrated therein (e.g., via the C++ programming language).

As illustrated, FIG. 3 is a Uniform Modeling Language (commonly referred to as “UML”) class collaboration diagram according to one embodiment of the present invention (see e.g., Fowler, UML Distilled: Brief Guide to the Standard Object Modeling Language, 3rd Edition, Addison-Wesley, 2004). The following classes are described in FIG. 3: JMS Client 310, SharedQueueController 320, ControlMessageHandler 320a and Control MessageBrowser 320b, Control Message 330, ControlQueue 340 and Shared Resource 350. FIG. 3 also shows the relationships between the different classes, according to one embodiment of the present invention. For example, JMS Client 310 has a one-to-one relationship to SharedQueueController 320, which has a one-to-one relationship with Shared Resource 350.

Additionally, as shown in FIG. 3, SharedQueueController 320 comprises both ControlMessageHandler 320a and ControlMessageBrower 320b and has a one-to-one relationship with each of those classes. ControlMessageHandler 320a and ControlMessageBrower 320b in turn, each have a one-to-many relationship with Control Message 330. As illustrated, Control Message 330 has a many-to-one relationship with Control Queue 340. The detail of each of these classes will be discussed further below, with reference to FIGS. 2 and 3. The details discussed below apply to the Java® programming language, and particularly the JMS API, which is a part of the J2EE library, and the IBM WebSphere® MQ JMS Provider.

In one aspect, shown in FIG. 2, each client (e.g., CL1 215, CL2 225 and CL3 235) may be implemented as a JMS Client 310 (shown in FIG. 3). For a general description of JMS Clients and there operations, see Farley et al., Java Enterprise in a Nutshell, O'Reilly, 2005. To access a shared resource (e.g., SR 240b), each JMS Client 310 creates a single SharedQueueController 320 (e.g., SQC 210, SQC 220 and SQC 230), which maintains the interest in SharedResource 350 (e.g., SR 240b) by continually, and automatically, replacing ControlMessages 330 on the ControlQueue 340 shortly before the current ControlMessage 330 from that client expires, as indicated by a time-to-live argument in a JMS Expiration property, and is removed from the ControlQueue 340 by the JMS provider (e.g., IBM WebSphere® MQ). As discussed in further detail below, a JMS Client 310 (e.g., CL1 215) will be considered to own a SharedResource 350 (e.g., SR 240b), for which it has registered an interest in, when the JMS Client 310 discovers (via a SharedQueueController 320) that its registration in a SharedResource 350 is currently the oldest on ControlQueue 340 (CQ 240a). Hence, ControlQueue 340 controls access to SharedResource 350 and JMS Client 310 indicates its interest in SharedResource 350 via SharedQueueController 320.

Each SharedQueueController 320 may be implemented as a Java® class, according to one embodiment of the present invention. For example, the Java® class shown in Table 1 could implement SharedQueueController 320.

TABLE 1
SharedQueueController Class

Method Summary
void register(javax.jms.Connection connection,

java.lang.String clientID ,
java.lang.String tokenName,
java.lang.boolean transacted ) throws JMSException

Enables a JMS client to register an interest in receiving messages from a SR. The client creates a
JMS Connection and passes a reference in this call, along with a String Identifier for the client, a
tokenName and a Boolean value to indicate if the JMS Session that is used to create a JMS
Queue Receiver should use transaction control.
If transacted = false then a JMS Message will be removed from the SR before it is passed to the
JMS client. In the event of a processing error in the client then the Message will not be recovered
to the SR. This option is best suited to non persistent messages
If transacted = true then a JMS Message will be remain on the SR until the JMS client issues an
explicit commit( ) method call. If an error occurs while processing the message then the client
should issue a rollback( ) method call . This option is best suited to persistent messages.
void deregister( java.lang.String clientID, java.lang.String tokenName )
Enables a JMS client to explicitly remove its registered interest in a SR.
javax.jms.
Message getNextMessage(java.lang.String sharedQueueName,

java.lang.boolean returnIfNotOwner,

java.lang.boolean returnIfEmpty,
java.lang.int timeOut )

throws JMSException
Gets the next available message from the SR if the (parent) JMS client owns the oldest registered
interest in the SR.
sharedQueueName is the JNDI administered object name for the SR.
When returnIfNotOwner = true the SQC will return a null Message if the JMS client does not
own the oldest registered CM. Otherwise the call will block until a JMS Message is received or a
time out interval expires as specified in the timeout parameter. This allows processing control to
return to the calling client immediately if it is not the current owner of the SR.
When returnIfEmpty = true the SQC will return a null Message, even if the JMS client owns the
oldest registered CM. Otherwise the call will block until a JMS Message is received or a time out
interval expires as specified in the timeout parameter. . This allows processing control to return
to the calling client immediately if there are no JMS Messages on the SR, rather than wait for the
specified timeout to expire.
The timeOut value specified the time in milliseconds that the SQC should wait to consume a
Message from the SR, before returning to the client. A value of zero means wait indefinitely.
void commit( ) throws JMSException
If the registration( ) call specifies that the Messages are to be consumed under transaction control
then this call will explicitly commit those message after the client has successfully processed
them. After this call the JMS Message will be removed from the SR.
void rollback( ) throws JMSException
If the registration( ) call specified that the Messages are to be consumed under transaction
control then this call will explicitly rollback those message if an error occurs while the client was
processing them. After this call the JMS Message will remain on the SR in its original queue
sequence.

As mentioned previously, each JMS Client 310 registering an interest in a shared resource within a JMS Provider negotiates the terms of that registration via arguments passed to the ControlMessage 330 during its creation by the SharedQueueController 320. Furthermore, each JMS client 310 suggests a transaction model (e.g., whether the JMS Messages are to be preserved until an acknowledgement is received by the JMS Client) and expire interval, but ultimately yields to the settings of the current owning (e.g., oldest registered) JMS Client. By yielding to the configuration setting of the currently owning JMS Client, a registering JMS Client operates as a “hot standby” of the current owner of the shared resource. If a SharedQueueController 320 registering with a Shared Resource 350 does not agree to the terms used by the current JMS Client (e.g., transaction model and expiration interval), the registering SharedQueue Controller 320 can choose to deregister its interest (thereby losing its place in ControlQueue 340), or wait to obtain ownership (and establish another set of terms to interact with Shared Resource 350).

As shown in FIG. 3, each SharedQueueController 320 comprises a single ControlMessageHandler 320a class. According to one embodiment of the present invention, ControlMessageHandler 320a is implemented as a Java® class that extends the standard Java® Thread class—e.g., may be defined as “private class ControlMessage Handler extends Thread” according to normal Java® syntax. Since ControlMessage Handler 320a extends the standard Java® Thread class, ControlMessage Handler 320a is executed on a separate thread with the Java® Virtual Machine. Moreover, Control MessageHandler 320a continuously creates and sends new ControlMessage 330 objects to the ControlQueue 340 at defined intervals (e.g., at the intervals defined by Shared QueueController 320 when registering with SharedResource 350), thereby maintaining a continuous registered interest in the SharedResource 350 for the operating duration of the JMS Client 310 that corresponds to the SharedQueueController 320 creating the ControlMessage 330 objects. In addition, according to one embodiment of the present invention, ControlMessageHandler 320a also implements a Java® Interface to allow a new interval to be set by the SharedQueueController 320—e.g., “Interface: public void setNewTimeOut(int newTimeOut)” may be defined according to standard Java® syntax.

Additionally, shown in FIG. 3, each SharedQueueController 320 comprises a single ControlQueueBrowser 320b class. According to one embodiment of the present invention, ControlQueueBrowser 320b is implemented as a Java® class that extends the standard Java® Thread class—e.g., may be defined as “private class ControlQueue Browser extends Thread” according to normal Java® syntax. Since ControlQueueBrowser 320b extends the standard Java® Thread class, ControlQueueBrowser 320b is executed on a separate thread with the Java® Virtual Machine. ControlQueueBrowser 320b allows the each SharedQueueController 320 to browse for ControlMessage 330 objects on the ControlQueue 340 for SharedResource 320, which match the registration “token” (described in further detail below) used by the SharedQueueController 320. ControlQueueBrowser 320b returns a true or false indicator to the SharedQueueController to indicate whether or not it has the owning interest in the shared resource after the match is identified. Thus, each ControlQueueBrowser 320b also functions to inform the corresponding SharedQueue Controller 320 if it has the owning interest in the SharedResource 350. Thus, in one embodiment, the SharedQueueController 320 delegates the responsibility of determining the ownership of the shared resource to the ControlQueueBrowser 320b. The SharedQueueController 320 only “knows” that it is the owner of the shared resource when it receives the “true” indicator from the CQB.

As mentioned above, ControlMessage 320 illustrated in FIG. 3 expires from ControlQueue 340 according to an expiration interval. The length of this interval is negotiated between each interested JMS Client 110 via their corresponding SharedQueue Controller 320. According to one embodiment of the present invention, a Control Message 330 contains a token, which is defined as a unique identifier logically associating SharedResource 350 within a specific JMS Provider, used for exchange of messages between clients. The token may be implemented as a simple Java® String, which is assigned automatically by the JMS provider. Alternatively, the token may be manually, and explicitly, assigned by the administrator of the JMS Provider. Consequently, each JMS Client 310 that has an interest in SharedResource 350 registers that interest with the corresponding ControlQueue 340 (in a process described in further detail below) using the same token identifier. According to one embodiment of the present invention, the only restriction with using tokens in this manner is that a token associated with Shared Resource 350 is unique within the JMS Provider domain (e.g., unique access all shared resources maintained by IBM's Websphere® MQ), and each token identifier can only be associated with one SharedResource 350.

If a client terminates abnormally then the Control Messages from that client will no longer be replaced on the Control Queue and that client's interest in the shared JMS Queue will lapse. A JMS client can explicitly deregister its interest in a shared JMS queue via its Shared Queue Controller.

The JMS client that owns the oldest unexpired registration message (or owning the ControlMessage 320 with the oldest timestamp) on the Control Queue for a particular token identifier is considered to be the current owner of the shared JMS queue associated with that token. If the client is not the current owner it can wait for its chance to gain ownership by allowing its Shared Queue Controller to maintain the interest by continuing to send Control Messages to the Control Queue. The assignment of ownership is a collaborative act between each SharedQueueController in the system. The Shared Queue Controller asserts that it will not assume ownership of a shared resource if it does not own the control message with the oldest timestamp.

As mentioned above, owner of the SharedResource 350 is the JMS Client 310 that has sole access to receive messages from that the SharedResource 350 by virtue of its SharedQueueController 320 discovering its registration (represented by Control Message 330) is the oldest in the Control Queue 340 corresponding to the SharedResource 350. Thus, when the current JMS Client 310 owner of SharedResource 350 terminates or relinquishes its controlling interest then the JMS Client 310 with the next oldest registered interest (as represented by ControlMessage 330) will become the owner of SharedResource 350. A client's Shared Queue Controller detects when its client has acquired ownership of the shared queue, and will receive messages from that queue on behalf of the client.

Use of ControlMessage 330 objects, to refresh interest and preserve eventual access to SharedResource 350 (via ownership), can be controlled between multiple JMS Client 310 objects connecting to the same JMS provider in a distributed environment, as illustrated in FIG. 2. Continuing with the use of Java® as an exemplary embodiment showing additional detail, each ControlMessage 330, according to one embodiment of the present invention, is based on the JMS Message class. In contrast with the typical use of a JMS Message class, ControlMessage 330 does not contain a message payload to be processed by a JMS Client 310, according to one embodiment of the present invention. Instead the JMS Message payload of ControlMessage 330 includes predefined JMS Properties, where one embodiment of the of the present inventions uses the predefined JMS properties to store data relating to the registered interest of a JMS Client 310 in a SharedResource 350 (e.g., SR 240b). Such data relating to the registered interest of a JMS Client include a transaction model and expiration interval, as discussed above. Example JMS properties used to store data relating to the registered interest of a JMS Client are shown in Table 2 and could be implemented as a JMS Message payload to ControlMessage 330.

TABLE 1
Exemplary ControlMessage JMS Properties

| Type | Property Name | Purpose |
|---|---|---|
| java.lang.Long | RegistrationTimeStamp | The value of System.currentTimeMillis( ) |
| | | when the JMS client first registered an |
| | | interest in a SR |
| java.lang.Long | LastUpdateTimeStamp | The value of System.currentTimeMillis( ) |
| | | when the SharedQueueController last added |
| | | a CM to the CQ. |
| Java.lang.String | TokenName | The Token identifier that is used to register |
| | | an interest in a SR. TokenNames are |
| | | assigned by the site administrator for the |
| | | JMS provider, and associated with a specific |
| | | shared JMS queue. |
| Java.lang.String | ClientID | The identifier of the JMS client that |
| | | registered interest in the SR, and which |
| | | owns the SQC that put the CM to the CQ. |
| java.lang.Int | TimeOut | The expiry interval in milliseconds for a CM |
| | | on the CQ. Each JMS client can request a |
| | | desired time out value, but only that |
| | | belonging to the oldest registered unexpired |
| | | CM is used by all SQCs. |

Continuing with the class collaboration diagram illustrated in FIG. 3, ControlQueue 340 is a shared JMS Queue dedicated to the use of all Shared Queue Controllers in the same JMS provider domain. Additionally, a JNDI administered object called “ControlQueue” is defined to the JMS Provider to accommodate access to Control Queue 340.

As discussed above, SharedQueueController 320 preserves the interest of JMS Client 310 in SharedResource 350 by sending ControlMessage 330 objects to ControlQueue 340. Since each ControlMessage 330 inherits JMS Message class properties, each ControlMessage 330 sets its JMS Expiration property to the TimeOut property (or time-to-live) value obtained from the oldest registered ControlMessage 330 on the ControlQueue 340 for the same registration TokenName. Based on the JMS Expiration property, as described above, each ControlMessage 330 will be automatically removed from the ControlQueue 340 by the JMS provider when its expiration time is exceeded. Thus, ControlQueue 340 is automatically cleared of ControlMessage 330 that are no longer relevant. In one embodiment, all SharedQueueController 320 registered for the same TokenName use the same TimeOut interval.

Thus, according to one embodiment of the present invention, SharedQueue Controller 320 for a JMS Client 310 will keep adding ControlMessage 330 to the ControlQueue 340 to maintain an interest in a TokenName (and its associated SharedResource 350). SharedQueueController 320 subsequently determines (e.g., via ControlQueueBrowser 320b) if its JMS Client 310 is the owner of the oldest ControlMessage 330 on the ControlQueue 340 for the registered TokenName. Upon such a determination, JMS Client 310 is then permitted to receive messages from the Shared Resource 350 (as indicated by CL1 215a in FIG. 2). Otherwise, if a non-owning JMS Client 310 attempts to pull a message from SharedResource 350, the attempt by the non-owning JMS Client 310 will be refused by its SharedQueueController 320 depending upon whether JMS Client 310 accepts the operating parameters (such as transaction model and expiration time) of the currently owning JMS Client to thereby act as a “hot standby” JMS Client for the currently owning JMS Client (e.g., CL2 225 and CL3 235 in FIG. 2 are “hot standbys” for CL1 215).

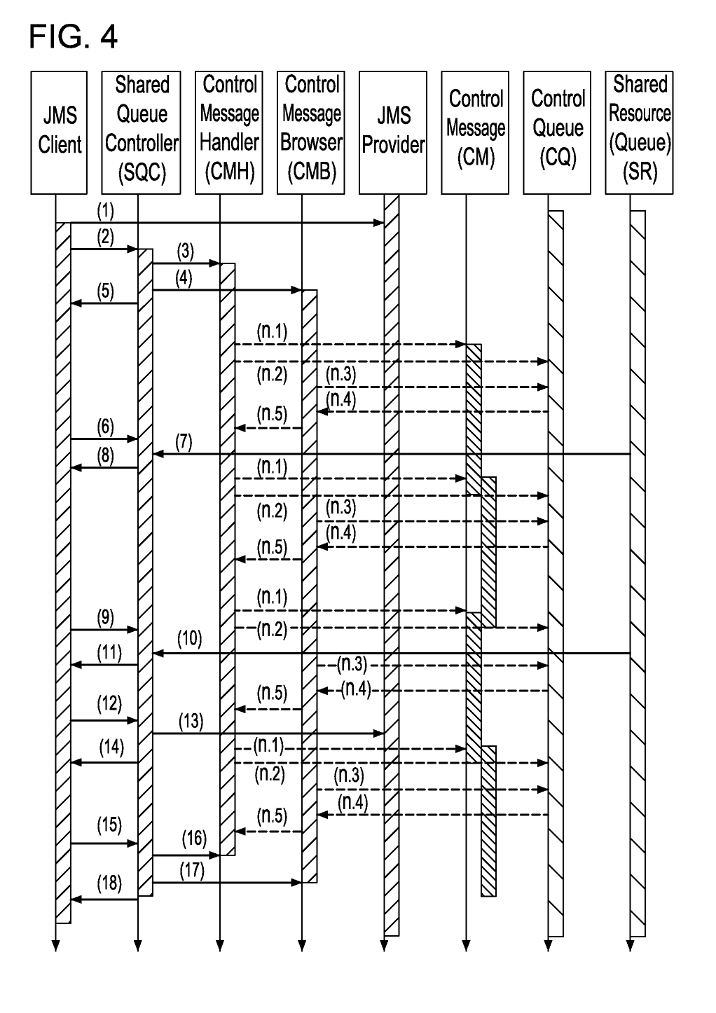

In FIG. 4, the operational details of the SharedQueueController 320, as it performs tasks for some JMS Client 310, are illustrated in a UML Sequence Diagram. Furthermore, in Table 3, the operations illustrated in FIG. 4 are described in detail, according to one embodiment of the present invention.

TABLE 2
Sequence key for FIG. 4

| Sequence | Action |
|---|---|
| 1 | JMS client creates a JMS Connection |
| 2 | JMS client calls register( ) method of the Shared Queue Controller |
| | (SQC) passing: |

clientID
tokenID
requiredTimeOut

| | |
|---|---|
| 3 | In the SQC: |

Create a JMS Session (CQSession) and JMS QueueSender

(CQSender ) for accessing the Control Queue (CQ) if
these were not already created.

Set Class member registrationTimeStamp = Java

System.currentTimeMillis( )

Start the Control Message Handler (CMH) on a separate

thread passing

CQSender,
registration_TimeStamp,
clientID
tokenID
oldestRegisteredTimeOut (see n.5)

(see n.1, n.2, n.5 below)

| | |
|---|---|
| 4 | In the SQC: |

Create a JMS QueueBrowser (CQBrowser) on the CQSession

if not already created. The CQBrowser is created with a
message selector for the TokenID property of the Control
Messages equal to the token ID passed on the register call.

Starts the Control Message Browser (CMB) on a separate

thread passing the CQbrowser (see n.3, n.4 below).

| | |
|---|---|
| 5 | SQC: return to calling JMS client |
| 6 | JMS Client: call getNextMessage( ) method of the SQC. |
| 7 | In the SQC: |

Check that it is owner of the oldest registered Control

Message (CM) on the CQ (see n.1 - n.5 below). Assuming
it is the owner then it:
Create a JMS Session (SQSession) for receiving from

the shared JMS Queue (SQ) if not yet created.

Create a JMS QueueReceiver (SQReceiver) on the

```
  SQSession and receives the next available JMS
  message from the SQ.
```

| | |
|---|---|
| 8 | SQC: passes the JMS Message back to the JMS client. |
| 9 | Repeat 6 |
| 10 | Repeat 7 |
| 11 | Repeat 8 |
| 12 | JMS client: call the commit( ) method on the SQC. |
| 13 | SQC: issues a commit( ) on the SQSession |
| 14 | SQC: return to JMS client. |
| 15 | JMS client: calls the deregister( ) method on the SQC. |
| 16 | In the SQC: |

Stop the CMH.
Close the CQSender.
Close the SQReceiver
Close the SQSession

| | |
|---|---|
| 17 | In the SQC: |

Stop the CMB
Close the CQBrower
Close the CQSession

| | |
|---|---|
| 18 | SQC: return to the JMS client. |

Following items repeat on time interval and separate threads

| | |
|---|---|
| n.1 | In the CMH: |

Create a Control Message;
Create Message property

RegistrationTimeStamp=regsistrationTimeStamp
LastUpdateTimeStamp=Java

System.currentTimeMillis( )

TokenName=tokenID
ClientID=clientID
If this is first CM on the CQ for this TokenID

TimeOut=oldestRegisteredTimeOut

Else

TimeOut=TimeOut value from current oldest
CM on the CQ

| | |
|---|---|
| n.2 | Send CM to the CQ |
| n.3 | Browse For Control Messages on the CQ |
| n.4 | All CMs that match the selectors set on the CQBrowser are |
| | returned as a java.lang.Enumeration. |
| n.5 | Work through the enumeration of Control Messages; |
| | If the clientID matches that of the Control Message with the |
| | oldest RegistrationTimeStamp then : |

Call setOldestTimeOut( ) method on the SQC passing

the requiredTimeOut

Call the setSharedQueueOwner( ) method on the SQC

Else

Call setOldestTimeOut( ) method on the SQC passing

the TimeOut value from the oldest registered CM.

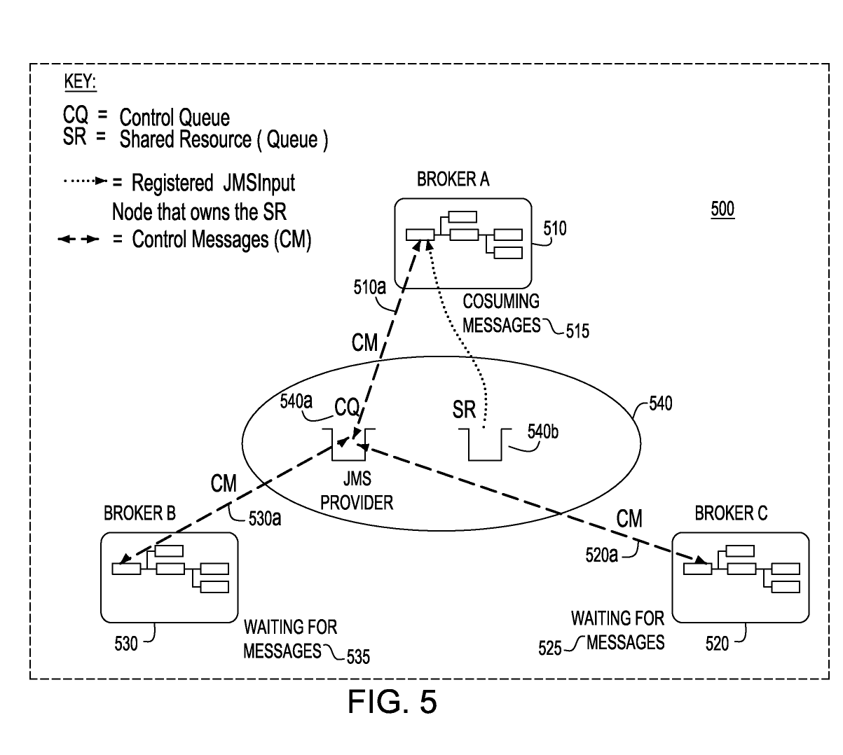

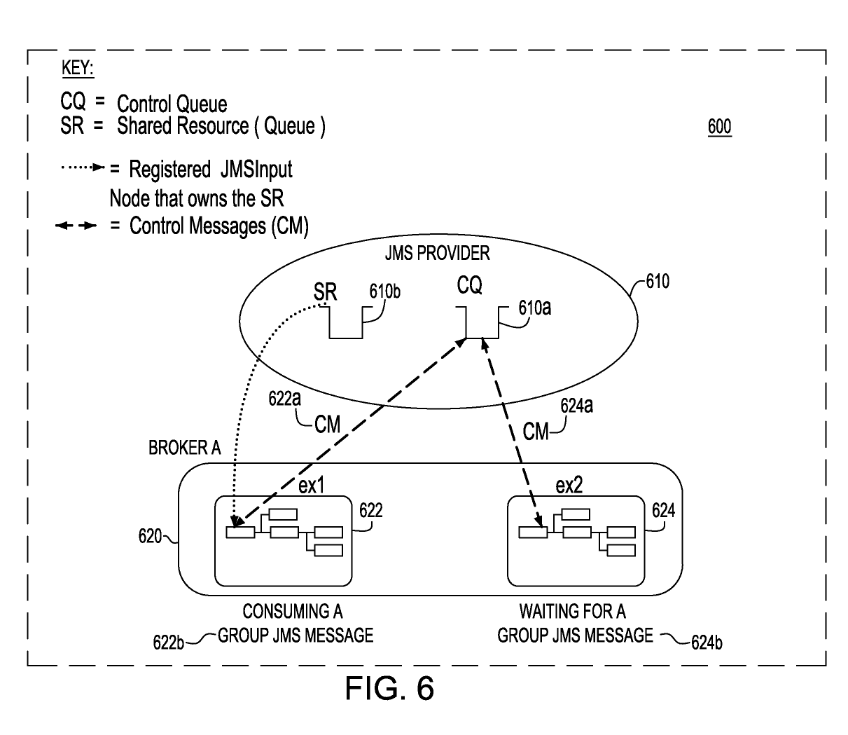

Although the embodiments discussed above illustrated the present invention in a typical MOM environment, one skilled in the art could, without undue experimentation, expand the descriptions above to other environments. For example, in FIGS. 5 and 6 below, embodiments of the present invention are shown as enabling robust message flows in a Enterprise Service Bus (or “ESB”) environment (see generally Chappell, “Enterprise Message Bus”, O'Reilly (2004)). Within the ESB environment, a message flow is defined as a processing of messages within a message environment (see Chappell, “Enterprise Message Bus” at pp. 66-68).

FIG. 5 describes multiple IBM WebSphere® Message Brokers, 510, 520 and 530. In FIG. 5, each Message Broker has a deployed message flow that contains a single JMS Client (e.g., a JMSInput node as described by IBM WebSphere® Message Broker) to receive input from the SR 540b. In addition, each Message Broker creates an SQC (not shown in FIG. 5, but see, e.g., SharedQueueController 320) and registers a token with that SQC, indicating that unique identifier of the Message Broker and JMS Provider as well as specifying that transactional support is required. Consequently, each Message Broker in each message flow uses the same registration token.

Moreover, as described above, each SQC creates a CMB (not shown in FIG. 5, but see, e.g., ControlMessageBrowser 320b) to start browsing all the CM objects, which have been created by the JMS Clients interested in receiving messages from the message flow (e.g., CM 510a and CM 520a, 530a), with the same registration token on the CQ 540a (e.g., CQ 610a and ControlQueue 340). The SQC on each Message Broker subsequently creates a single CMH (not shown in FIG. 5, but see, e.g., ControlMessageHandler 320a) to send CM objects to CQ 540a. Each Message Broker then calls its SQC to get the next JMS Message from SR 540b.

In FIG. 5, the JMS Client in the message flow running on Broker 510 was the first to register an interest in the SR 540b. As described above, Message Broker 510 is therefore the owner of the SR 540b and has sole access to the messages residing on that resource. In response to the JMS Client on Message Broker 510 receiving a JMS Message from the SR 540b, and after each message is successfully processed, the JMS Client on Message Broker 510 client signals the JMS Provider to remove the message; e.g., via the commit( ) method on its SQC. As a result of the commit( ) method (e.g., as described in table 2), the JMS provider will remove all references to the processed message from SR 540b.

In addition, the JMS Clients on Brokers 520 and 530 are waiting to obtain access to the SR 540b (as illustrated in reference characters 525 and 535). If, during the processing of one message, the message flow on Message Broker 510 experiences an unhandled error (or exception) and the flow stops unexpectedly, the SQC for the JMS Client on Message Broker 510 will also terminate. Consequently, since the SQC for Message Broker 510 terminated, CM objects from Message Broker 510 will no longer be sent the CQ 540a (as described above).

Once the CM objects from Message Broker 510 expire from the CQ 540a, in the example illustrated in FIG. 5, the CM object from Message Broker 530 become the oldest registered CM object on CQ 540a. In response to the JMS Client on Message Broker 530 calling its SQC to obtain messages from the SR 540b, as indicated by reference character 525, the SQC determines whether its associated JMS Client is now the owner of the SR 540b (as described above). Furthermore, to ensure recovery of any missed JMS Messages once ownership of the shared resource has changed, e.g., as a consequence of Message Broker's 510 premature termination, the JMS Client on Message Broker 530 delays receiving input from the SR 540b for a predetermined period of time, e.g., 2 processing cycles. Thus, the delay by JMS client on Message Broker 530 allows the JMS Client on Message Broker 510 time to take emergency action, if the JMS Client on Message Broker 510 remains operational; e.g., the JMS Client on Message Broker 510 could transmit a commit message, or take other action to ensure a clean termination. Thereafter, Message Broker 530 begins receiving JMS Messages from the SR 540b and processing those messages.

When the message flow on Message Broker 510 resumes, however, the JMS Client may again create a SQC and registers an interest in the SR 540b (as described above). Since Message Broker 510 lost its place in CQ 540a, it will have the youngest registration timestamp in CQ 540a. Therefore, the example shown in FIG. 5, Message Broker 510 will wait for the message flows on both Broker 530 and Broker 520 to either stop or relinquish their interest in SR 540b before it can again receive input.

FIG. 6 illustrates an alternative embodiment of the present invention. In FIG. 6 multiple IBM WebSphere® Message Broker execution groups (e.g., ex1 622 and ex2 624) are running on Message Broker 620. Each execution group has a single message flow which contains a single JMS Client (e.g., a JMSInput node as described by IBM WebSphere® Message Broker) connected to a shared resource. As described above, each input node creates an SQC (not shown in FIG. 6, but see, e.g., SharedQueueController 320) and registers a token with that SQC specifying that transactional support is required. Each input nodes in each message flow uses the same registration token.

Additionally, each SQC creates a CMB (not shown in FIG. 6, but see, e.g., ControlMessageBrowser 320b) to start browsing CM objects (e.g., CM 622a and CM 624a, as well as ControlMessage 330) with the same registration token on the CQ (e.g., CQ 610a and ControlQueue 340). Furthermore, each SQC creates a single CMH (not shown in FIG. 6, but see, e.g., ControlMessageHandler 320a) to send CM objects to the CQ 610a. Each input node then calls its SQC to get the next JMS Message from SR 610b.

In FIG. 6, the JMS Client in the message flow running in execution group ex1 622 was the first to register an interest in SR 610b. As described above, ex1 622 is therefore the owner of SR 610b and has sole access to messages on that queue. The JMS Client in execution group ex1 622 receives a JMS Message from SR 610b and reads the JMS Message group ID and Sequence number (as described previously).

The JMS Client in execution group ex1 622 continues to receive JMS Messages from SR 610b, until it finds the last message in the JMS Message group. As described above, ex1 622 calls the commit( ) method (e.g., as described in Table 2) on the SQC followed by the deregister( ) method (e.g., as described in table 2). Furthermore, after calling the deregister( ) method, SQC closes both the CMH and CMB. Consequently, the CM object(s) for execution group ex1 622 will expire from CQ 610a, indicating SR 610b is available to the next available client. For example, in FIG. 6, the JMS Client in execution group ex2 624 becomes the owner of the SR 610b and starts to process the next JMS Message in the same way described above.

If the JMS Client on execution group ex1 622 again registers its interest in the SR 610b, the corresponding CM 622a will have the youngest registration timestamp on CQ 610a. Therefore, ex1 622 will wait for the message flows on execution group ex2 624 to stop and ex2 624 deregisters its interest (as described above) before ex1 622 can resume receiving input.

Note that this particular embodiment does not require that the group messages be placed back on queue in their original sequence in the event of a failure, since the messages will be consumed or recovered as a single logical unit. In this case it is the completeness of the group message that is of concern and not where that group is placed on the queue.

While the proceeding paragraphs describe a control queue (e.g., the CM) that regulates access to a shared resource, a software component that manages a client's interest in the shared resource (e.g., the SQC) and a registration mechanism (e.g., the generation handling of CM objects) in a point-to-point message topology within a MOM framework, and other configurations are possible.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

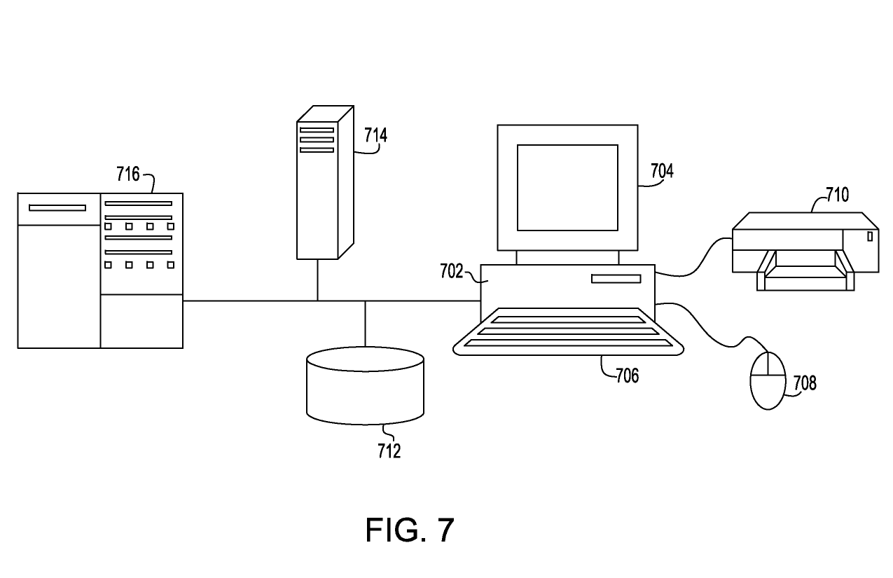

Referring now to FIG. 7, the systems and methodologies of the present disclosure may be carried out or executed in a computer system that includes a processing unit 720, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit 720 by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 704 for presenting output displays and providing a display through which the user may input data and interact with the processing system, for instance, in cooperation with input devices such as the keyboard 806 and mouse device 708 or pointing device. The computer processing system may be also connected or coupled to one or more peripheral devices such as the printer 710, scanner (not shown), speaker, and any other devices, directly or via remote connections. The computer processing system may be connected or coupled to one or more other processing systems such as a server 710, other remote computer processing system 714, network storage devices 712, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 702, 714, 718), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of controlling access to a messaging system that exchanges messages in a distributed data processing system that includes a plurality of computing devices, comprising:
sending a control message from a first computing device to a storage medium on a second computing device, wherein the storage medium includes a first queue and wherein the control message includes a token that corresponds to a shared resource of the messaging system and identifies a registering computing device that has an interest-to-use the shared resource;
storing the control message on the first queue;
browsing for oldest control message in the first queue, wherein the registering computing device associated with the oldest control message gains access to the shared resource.

2. The method of claim 1, further comprising continually sending a control message periodically according to a predetermined time interval, to the first queue until the first computing device has access to the shared resource.

3. The method of claim 1, wherein a plurality of first computing devices sends a plurality of corresponding control messages to register an interest to use the shared resource.

4. The method of claim 1, wherein the control message expires after a predetermined time interval, and the control message that is expired is deleted from the first queue.

5. The method of claim 1, wherein the registering computing device waits for a predetermined time before gaining access to the shared resource.

6. A program storage device readable by a machine, tangibly embodying a program of instructions executable by the machine to perform a method of controlling access to a messaging system that exchanges messages in a distributed data processing system that includes a plurality of computing devices, comprising:
sending a control message from a first computing device to a storage medium on a second computing device, wherein the storage medium includes a first queue and wherein the control message includes a token that corresponds to a shared resource of the messaging system and identifies a registering computing device that has an interest-to-use the shared resource;
storing the control message on the first queue;
browsing for oldest control message in the first queue, wherein the registering computing device associated with the oldest control message gains access to the shared resource.

7. The program storage device of claim 6, further comprising continually sending a control message periodically according to a predetermined time interval, to the first queue until the first computing device has access to the shared resource.

8. The program storage device of claim 6, wherein a plurality of first computing devices sends a plurality of corresponding control messages to register an interest to use the shared resource.

9. The program storage device of claim 6, wherein the control message expires after a predetermined time interval, and the control message that is expired is deleted from the first queue.

10. The program storage device of claim 6, wherein the registering computing device waits for a predetermined time before gaining access to the shared resource.

11. A system for controlling access to a messaging system that exchanges messages in a distributed data processing system that includes a plurality of computing devices, comprising:
a computing device having a storage medium;
a plurality of client computing devices operable to send a control message to the storage medium on the computing device, wherein the storage medium includes a first queue and wherein the control message includes a token that corresponds to a shared resource of the messaging system and identifies a registering computing device that has an interest-to-use the shared resource, the plurality of client computing devices further operable to browse for oldest control message in the first queue, wherein the registering computing device associated with the oldest control message gains access to the shared resource.

12. The system of claim 11, wherein the plurality of client computing devices is further operable to continually send a control message periodically according to a predetermined time interval, to the first queue until the first computing device has access to the shared resource.

13. The system of claim 11, wherein the control message expires after a predetermined time interval, and the control message that is expired is deleted from the first queue.

14. The system of claim 11, wherein the registering computing device waits for a predetermined time before gaining access to the shared resource.
